(19) United States
(12) Patent Application Publication
(10) Pub. No.: US 2026/0184847 A1
(43) Pub. Date: Jul. 2, 2026

(54) POLYESTER PLASTICIZER HAVING HIGH COLD RESISTANCE AND POLYVINYL CHLORIDE COMPOSITION INCLUDING THE SAME

(71) Applicant: NAN YA PLASTICS CORPORATION, TAIPEI (TW)

(72) Inventors: CHING-YAO YUAN, TAIPEI (TW); WEN-HUA LU, TAIPEI (TW); Chi-Lin Chen, TAIPEI (TW)

(21) Appl. No.: 19/095,011

(22) Filed: Mar. 30, 2025

(30) Foreign Application Priority Data
Dec. 30, 2024 (TW) 113151392

(51) Int. Cl. C08G 63/695; C08G 63/91; C08L 27/06

(52) U.S. Cl. CPC C08G 63/6956; C08G 63/916; C08L 27/06; C08L 2205/06

(57) ABSTRACT

A polyester plasticizer having high cold resistance and a polyvinyl chloride composition including the same. The polyester plasticizer can be obtained by an esterification reaction of a diacid component with a diol component followed by end-capping with an end-capping agent. The diacid component is sebacic acid. The diol component includes a first diol and a second diol. The first diol is diethylene glycol, and the second diol is a diol having a silicon-oxygen structural unit, a linear chain structure, or a branched chain structure. Therefore, the polyester plasticizer can be used in a polyvinyl chloride composition, so as to improve low-temperature resistance, bendability, and plasticizer blooming resistances of a resulting PVC soft product.

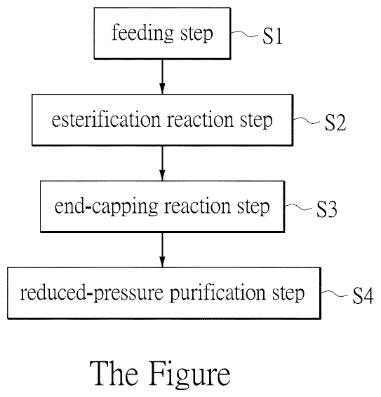

### CROSS-REFERENCE TO RELATED PATENT APPLICATION

This application claims the benefit of priority to Taiwan Patent Application No. 113151392, filed on Dec. 30, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester plasticizer and applications thereof, and more particularly to a polyester plasticizer having high cold resistance and a polyvinyl chloride composition thereof.

### BACKGROUND OF THE DISCLOSURE

Plasticizer is an important additive for thermoplastics, and can improve the fluidity and plasticity of the thermoplastics during processing and molding. It is well known that polyvinyl chloride has an inseparable relationship with plasticizers. A polyvinyl chloride material with one or more plasticizers added therein can be made into PVC soft products, such as films and leathers.

Plasticizers come in many types, including phthalate plasticizers such as DEHP, DBP, BBP, DINP, DIDP and DNOP. These plasticizers present toxicity concerns and are restricted in use. Therefore, some manufacturers in the relevant industries use polyester plasticizers in place of the aforementioned toxic plasticizers. However, polyester plasticizers are prone to precipitation in practical applications, which can negatively affect the appearance, physical properties, and mechanical properties of subsequent processed products.

Generally, soft PVC products (such as PVC leathers) are not suitable for use in environments with extremely low temperatures. They become brittle in such environments and are prone to cracking and breaking during use.

In conclusion, soft PVC products may have a plasticizer blooming effect, and may not meet the required performance in some aspects such as low-temperature resistance and bending resistance.

### SUMMARY OF THE DISCLOSURE

In response to the above-referenced technical inadequacies, the present disclosure provides a polyester plasticizer having high cold resistance and a polyvinyl chloride composition including the same. One aspect of the present disclosure is carrying out an esterification reaction of sebacic acid with diethylene glycol and a diol having a silicon-oxygen structural unit, a linear chain structure, or a branched chain structure, such that a resulting polyester plasticizer can have an improvement in cold resistance and retention in plasticized products.

In order to solve the above-mentioned problems, one of the technical aspects adopted by the present disclosure is to provide a polyester plasticizer having high cold resistance, which is obtained by an esterification reaction of a diacid component with a diol component followed by end-capping with an end-capping agent. The diacid component is sebacic acid. The diol component includes a first diol and a second diol. The first diol is diethylene glycol, and the second diol is a diol having a silicon-oxygen structural unit, a linear chain structure, or a branched chain structure.

In one of the possible or preferred embodiments, the polyester plasticizer having high cold resistance has a structure as represented by formula I:

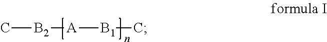

in formula I, A represents a residue of the sebacic acid; B₁ and B₂ each independently represent a residue of the first diol or the second diol; C represents a residue of the end-capping agent; and n is a positive integer from 1 to 4.

In one of the possible or preferred embodiments, the diol having the silicon-oxygen structural unit has a structure as represented by formula II:

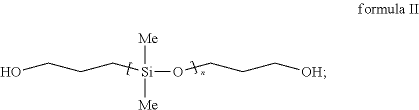

Me in formula II represents a methyl group; the diol having the linear chain structure is 1,12-dodecanediol; the diol having the branched chain structure is 2-butyl-2-ethyl-1,3-propanediol; and n is a positive integer from 1 to 12.

In one of the possible or preferred embodiments, the second diol is the diol having the silicon-oxygen structural unit. B₁ and B₂ in formula I each independently represent a residue derived from the diethylene glycol or the diol having the silicon-oxygen structural unit.

In one of the possible or preferred embodiments, the second diol is the diol having the linear chain structure. B₁ and B₂ in formula I each independently represent a residue derived from the diethylene glycol or the diol having the linear chain structure.

In one of the possible or preferred embodiments, the second diol is the diol having the branched chain structure. B₁ and B₂ in formula I each independently represent a residue derived from the diethylene glycol or the diol having the branched chain structure.

In one of the possible or preferred embodiments, the end-capping agent is an acid end-capping agent or an alcohol end-capping agent.

In one of the possible or preferred embodiments, the end-capping agent is lauric acid.

In order to solve the above-mentioned problems, one of the technical aspects adopted by the present disclosure is to provide a polyvinyl chloride composition for manufacturing a soft product. The polyvinyl chloride composition includes 100 parts by weight of a polyvinyl chloride component, a plasticizer component, a stabilizer, and at least one inorganic additive, and the plasticizer component includes the polyester plasticizer having high cold resistance as described above.

In one of the possible or preferred embodiments, the plasticizer component further includes a C9-C11 phthalate, and the C9-C11 phthalate and the polyester plasticizer having high cold resistance are in the ratio of 3:1.

In conclusion, the polyester plasticizer having high cold resistance provided by the present disclosure, in which a main molecule chain contains a sebacic acid residue and a diethylene glycol residue and a residue derived from a diol having a silicon-oxygen structural unit (such as a silicon-oxygen bond or silicon-oxygen chain), a diol having a linear chain structure (such as 1,12-dodecanediol), or a diol having a branched chain structure (such as 2-butyl-2-ethyl-1,3-propanediol) linked to the sebacic acid residue, has excellent cold resistance and migration resistance characteristics, and can be used in a polyvinyl chloride composition, so as to improve a resulting PVC soft product in terms of low-temperature resistance, bendability, and plasticizer blooming.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

The FIGURE is a flowchart of a method for manufacturing a transparent flame-retardant sheet having a high chlorine content of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

PVC materials are widely used in applications, and can be made into PVC soft products such as films and leathers due to the addition of a plasticizer. However, such PVC materials may exhibit plasticizer precipitation (plasticizer blooming) during use and do not meet required properties in some aspects, such as low-temperature and bending resistances. Hence, the present disclosure provides a polyester plasticizer having high cold resistance, in which a main molecule chain contains repeating units derived from a diacid having a long carbon chain and a diol having a silicon-oxygen structural unit, a linear chain structure, or a branched chain structure. Therefore, the polyester plasticizer of the present disclosure can have improved cold resistance, migration resistance, and extraction resistance, and can thus improve low-temperature and bending resistances of a resulting PVC soft product.

### Polyester Plasticizer Having High Cold Resistance

In the present disclosure, the polyester plasticizer is obtained by an esterification reaction of a diacid component with a diol component followed by end-capping with an end-capping agent. The diacid component suitable for use in the present disclosure can be selected from aliphatic diacids, and is preferably sebacic acid. The diol component suitable for use in the present disclosure can include a first diol and a second diol. The first diol is diethylene glycol, and the second diol is a diol having a silicon-oxygen structural unit, a linear chain structure, or a branched chain structure. Therefore, the polyester plasticizer of the present disclosure has a larger molecular weight, and can have a main molecule chain with a silicon-oxygen structural unit (such as a silicon-oxygen bond or silicon-oxygen chain) and one of a long carbon side chain or a branched side chain, so as to improve low temperature and bending resistances and plasticizer blooming of a resulting PVC soft product.

More specifically, the polyester plasticizer of the present disclosure has a weight average molecular weight from 2000 g/mol to 5000 g/mol. The polyester plasticizer has a structure as represented by formula I:

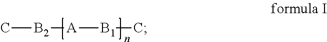

in formula I, A represents a residue of an aliphatic diacid such as a sebacic acid residue; B₁ and B₂ each independently represent a residue of the first diol or the second diol, in which the first diol is diethylene glycol, and the second diol is a diol having a silicon-oxygen structural unit, a linear chain structure, or a branched chain structure; C represents a residue of the end-capping agent; and n is a positive integer from 1 to 4.

It is worth mentioning that the diol component involved in the esterification reaction includes two different diols, i.e., diethylene glycol and a diol having a silicon-oxygen structural unit, a linear chain structure, or a branched chain structure. Therefore, the residues of the two different diols are both present in the structure represented by formula I. For example, in formula I, the structural units (i.e., monomer units) of A and B₁ can constitute a repeating unit, B₁ in one of a plurality of repeating units represents a diethylene glycol residue, and B₂ represents a residue of a diol having a silicon-oxygen structural unit, a linear chain structure, or a branched chain structure.

In one embodiment of the present disclosure, the polyester plasticizer includes 100 mol % of one or more diacid residues and 100 mol % of one or more diol residues. As the second diol, the diol having a silicon-oxygen structural unit preferably has the structure represented by formula II:

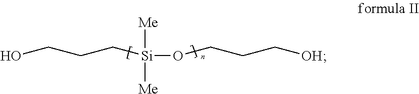

in formula II, Me represents a methyl group; and n is a positive integer from 1 to 12.

In another one embodiment of the present disclosure, as the second diol, the diol having a linear chain structure is preferably 1,12-dodecanediol.

In yet another one embodiment of the present disclosure, as the second diol, the diol having a branched chain structure is preferably 2-butyl-2-ethyl-1,3-propanediol (BEPD).

### Manufacturing Method of Polyester Plasticizer Having High Cold Resistance

Referring to THE FIGURE, a flowchart of a manufacturing method of a polyester plasticizer having high cold resistance of the present disclosure is shown. As shown in THE FIGURE, the polyester plasticizer having high cold resistance of the present disclosure can be prepared by the following steps: a feeding step S1, an esterification reaction step S2, an end-capping reaction step S3, and a reduced-pressure purification step S4.

In the feeding step S1, a diacid component, a diol component, and a catalyst are put into a reactor to form a reaction system, in which a mass ratio of the diol component to the diacid component can be from 1.1-1.3:1. The catalyst can be, but is not limited to, a titanium catalyst, such as tetrabutyl titanate (TNBT).

In the esterification reaction step S2, the reaction system can undergo an esterification reaction in two different temperature ranges under reflux and condensation. The end-capping reaction step S3 is executed when an acid value is detected to be less than 100 mgKOH/g. A first temperature range is from 120° C. to 150° C., a second temperature range is from 190° C. to 220° C., and an average temperature rising rate is 20° C./hour. If necessary, the esterification reaction step S2 can be executed in more than two temperature ranges that are arranged in order from low temperature to high temperature.

In the end-capping reaction step S3, an end-capping agent is put into the reactor to perform end-capping on a product of the esterification reaction under reflux and condensation. The reduced-pressure purification step S4 is executed when an acid value is detected to be less than 30 mgKOH/g. An amount of the end-capping agent can be 10% to 20% of a total mass of the reaction system, and a temperature of the end-capping reaction can be controlled in the range from 150° C. to 180° C.

In reduced-pressure purification step S4, a crude ester product obtained in the end-capping reaction step S3 is subjected to reduced-pressure distillation to remove undesirable components in the crude ester product under the conditions of a pressure lower than 760 torr and a temperature from 150° C. to 180° C., so as to obtain the polyester plasticizer of the present disclosure. In practice, the reduced-pressure purification step S4 can be executed in a pressure range from 10 torr to 750 torr. If necessary, the pressure range of the reduced-pressure purification step S4 can be divided into a plurality of ranges that are arranged in order from high pressure to low pressure.

### Polyvinyl Chloride Composition

The present disclosure provides a polyvinyl chloride composition, which mainly includes 100 parts by weight of a polyvinyl chloride component, a plasticizer component, a stabilizer, and at least one inorganic additive. It should be noted that the plasticizer component includes the polyester plasticizer having high cold resistance as described above. Therefore, soft products such as leathers made of the polyvinyl chloride composition of the present disclosure are suitable for extremely low temperature areas or environments (e.g., cold rooms).

In one embodiment of the present disclosure, the plasticizer component can further include a C9-C11 phthalate (911P), which is produced by esterifying C9-C11 mixed alcohol and phthalic anhydride and has excellent cold resistance. The C9-C11 phthalate and the polyester plasticizer having high cold resistance as described above are in the ratio of 3:1. Preferably, the stabilizer is a barium-zinc stabilizer, and the inorganic additive is calcium carbonate.

If necessary, the polyvinyl chloride composition of the present disclosure can further include at least one functional additive, such as but not limited to a lubricant, an antioxidant, a UV absorber, an impact modifier, a processing aid, and/or a colorant.

### Example 1

Sebacic acid, Diol-A (a diol having a structure as shown in formula II), diethylene glycol, and tetrabutyl titanate are added into an esterification reactor in the amounts as shown in Table 1, and a phosphorus-containing antioxidant (TPP) is added to a resulting reaction system. Afterwards, the reaction system undergoes an esterification reaction in the reactor, in which a temperature in the reactor is raised to 120° C. and maintained for 1 hour, and is then raised to 200° C. in a stepwise manner and maintained for 3 hours. When an acid value is detected to be less than 100 mgKOH/g, an end-capping agent is added into the reactor to perform end-capping on a product of the esterification reaction. The end-capping is terminated until an acid value is detected to be less than 30 mgKOH/g. Afterwards, a resulting crude ester product is subjected to reduced-pressure distillation under the conditions as follows: a pressure in the reactor being reduced to 50 torr; a temperature in the reactor being reduced to less than 180° C.; and a nitrogen flow rate being controlled at 100 Nm³/Hr. A polyester plasticizer is obtained when an acid value is detected to be less than 1 mgKOH/g.

### Example 2

The polyester plasticizer of Example 2 is prepared by the method and conditions described in Example 1, in which 1,12-dodecanediol is used in place of the Diol-A, and the esterification reaction components of Example 2 are added in the amount as shown in Table 1.

### Example 3

The polyester plasticizer of Example 3 is prepared by the method and conditions described in Example 1, in which 2-butyl-2-ethyl-1,3-propanediol is used in place of the Diol-A, and the esterification reaction components of Example 3 are added in the amount as shown in Table 1.

### Example 4

The polyester plasticizer of Example 4 is prepared by the method and conditions described in Example 1, in which neopentyl glycol (NPG) is used in place of the diethylene glycol, and the esterification reaction components of Example 4 are added in the amount as shown in Table 2.

### Example 5

The polyester plasticizer of Example 5 is prepared by the method and conditions described in Example 1, in which 2-methyl-1,3-propanediol (MPO) is used in place of the diethylene glycol, and the esterification reaction components of Example 5 are added in the amount as shown in Table 2.

### Example 6

The polyester plasticizer of Example 6 is prepared by the method and conditions described in Example 1, in which the diethylene glycol is used alone as a diol component, 2-ethyl hexanol (2-EH) being an alcohol end-capping agent is used in place of an acid end-capping agent, and the esterification reaction components of Example 6 are added in the amount as shown in Table 3.

### Example 7

The polyester plasticizer of Example 7 is prepared by the method and conditions described in Example 1, in which the diethylene glycol is used alone as a diol component, and the esterification reaction components of Example 7 are added in the amount as shown in Table 3.

### COMPARATIVE EXAMPLE

The polyester plasticizer of Comparative Example is prepared by the method and conditions described in Example 1, in which adipic acid is used as a diacid component, the combination of 2-methyl-1,3-propanediol (MPO) and neopentyl glycol (NPG) is used as a diol component, and the esterification reaction components of Comparative Example are added in the amount as shown in Table 1.

Each of the polyester plasticizers of Examples 1-7 and the Comparative Example is used in combination with a C9-C11 phthalate (911P) in a polyvinyl chloride, in which the polyester plasticizer and the 911P are in the ratio of 3:1 and mixed with an appropriate amount of calcium carbonate as an inorganic filler and a barium-zinc stabilizer. Resulting polyvinyl chloride compositions are made into samples to be tested for glass transition temperature, bending resistance at low temperature, and plasticizer retention. Test methods are described as follows, and test results are shown in Table 1 to Table 3.

Glass transition temperature (Tg): using a dynamic mechanical analyzer (DMA) to test a sample.

Bending resistance at low temperature: using a cold resistance tester with fixtures to repeatedly bend a sheet sample having a width of 5 cm and a length of 14.5 cm at a certain angle for a certain number of times in a −20° C. environment and observing its damage state.

Plasticizer retention (expressed as migration rate): placing a sheet sample in a 120° C. oven for 7 days, analyzing a mass difference of the sheet sample before and after baking, and calculating a migration rate by the following equation:

$$Migration rate = \frac{Δ W}{A \times t}$$

In the equation, ΔW represents the mass difference (mg) of the sheet sample before and after baking; A represents an area (dm²) of the sheet sample placed in a test plate, and t represents a test time (days).

TABLE 1

| | | | Comparative | | |
|---|---|---|---|---|---|
| Unit: % | | | Example | Example 1 | Example 2 |
| Esterification | Diacid | Adipic | 50.3 | — | — |
| reaction | component | acid | | | |
| components | | Sebacic | — | 49.5 | 50.1 |
| | | acid | | | |
| | Diol | MPO | 19.8 | — | — |
| | component | NPG | 10.4 | — | — |
| | | Diol-A | — | 23.8 | — |
| | | DEG | — | 11.5 | 13.8 |
| | | BEPD | — | — | — |
| | | 1,12- | — | — | 24.2 |
| | | Dodecanediol | | | |
| | End- | Lauric acid | — | 15.2 | 11.9 |
| | capping | 2-EH | 19.5 | — | — |
| | agent | | | | |

| Physical | Acid value | 2 | 1.2 | 0.80 |
|---|---|---|---|---|
| properties of | (mgKOH/g) | | | |
| plasticizer | Color | 1.5 | 100 | 80 |
| | (APHA) | | | |
| | Tg (° C.) | | −65 | −78.6 |
| Test | DMA Tg | 1.5 | 0.2 | −2.5 |
| results | (° C.) | | | |
| | Bending | 3 | 4000 | 8000 |
| | resistance | | | |
| | at −20° C. | | | |
| | (number | | | |
| | of times) | | | |
| | Migration | | 2.89 | 1.85 |
| | rate (%) | | | |

TABLE 2

| Unit: % | | | Example 3 | Example 4 | Example 5 |
|---|---|---|---|---|---|
| Esterification | Diacid | Adipic | — | — | — |
| reaction | component | acid | | | |
| components | | Sebacic | 50.3 | 50.6 | 52.3 |
| | | acid | | | |
| | Diol | MPO | — | — | 12.7 |
| | component | NPG | — | 15.1 | — |
| | | Diol-A | — | 13.9 | 13.2 |
| | | DEG | 14.2 | — | — |
| | | BEPD | 19.2 | — | — |
| | | 1,12- | — | — | — |
| | | Dodecanediol | | | |
| | End- | Lauric acid | 16.3 | 18.7 | 19.2 |
| | capping | 2-EH | — | — | — |
| | agent | | | | |
| Physical | | Acid value | 2 | 0.9 | 1.0 |
| properties of | | (mgKOH/g) | | | |
| plasticizer | | Color | 1.5 | 80 | 98 |
| | | (APHA) | | | |
| | | Tg (° C.) | | −72.4 | −66.8 |
| Test | | DMA Tg | 1.5 | −0.9 | 0.2 |
| results | | (° C.) | | | |
| | | Bending | 3 | 6000 | 4000 [symbol] |
| | | resistance | | | |
| | | at −20° C. | | | |
| | | (number | | | |
| | | of times) | | | |
| | | Migration | | 2.35 | 2.18 |
| | | rate (%) | | | |

TABLE 3

| Unit: % | | | Example 6 | Example 7 |
|---|---|---|---|---|
| Esterification | Diacid | Adipic | — | — |
| reaction | component | acid | | |
| components | | Sebacic | 50.1 | 51.3 |
| | | acid | | |
| | Diol | MPO | — | — |
| | component | NPG | — | — |
| | | Diol-A | — | — |
| | | DEG | 13.7 | 23.8 |
| | | BEPD | — | — |
| | | 1,12- | 5.6 | — |
| | | Dodecanediol | | |
| | End- | Lauric acid | — | 20.3 |
| | capping | 2-EH | 14.8 | — |
| | agent | | | |

| Physical | Acid value | 1.2 | 1.3 |
|---|---|---|---|
| properties of | (mgKOH/g) | | |
| plasticizer | Color | 100 | 100 |
| | (APHA) | | |
| | Tg (° C.) | −65 | −65.2 |
| Test | DMA Tg | 0.2 | 0.7 |
| results | (° C.) | | |
| | Bending | 4000 | 3500 |
| | resistance | | |
| | at −20° C. | | |
| | (number | | |
| | of times) | | |
| | Migration | 2.89 | 2.71 |
| | rate (%) | | |

It can be seen from the comparison between Examples 1-3 and the Comparative Example that the polyester plasticizer of the present disclosure, in which a main molecule chain contains a sebacic acid residue and a diethylene glycol residue and a residue derived from a diol having a silicon-oxygen structural unit, a linear chain structure, or a branched chain structure linked to the sebacic acid residue, can have an improvement in low temperature and bending resistances and plasticizer blooming of plasticized products.

It can be seen from the comparison between Example 1 and Examples 2 and 3 that the polyester plasticizer, which is prepared by the esterification reaction of the combination of diethylene glycol and a diol having a silicon-oxygen structural unit with sebacic acid, has better bending resistance at low temperature and better plasticizer retention than that prepared by the esterification reaction of the combination of diethylene glycol and a diol having a linear or a branched chain structure with sebacic acid.

It can be seen from the comparison between Examples 4 and 5 and Examples 1-3 that the polyester plasticizer, which is prepared by the esterification reaction of sebacic acid with the combination of diethylene glycol and a diol having a silicon-oxygen structural unit, a linear chain structure, or a branched chain structure, has a significant increase in bending resistance at low temperature. It can be seen from the comparison between Example 7 and Examples 1-3 that compared to the polyester plasticizer obtained by using diethylene glycol alone as a diol component, the polyester plasticizer obtained by using the combination of diethylene glycol and a diol having a silicon-oxygen structural unit, a linear chain structure, or a branched chain structure as a diol component has a significant increase in bending resistance at low temperature.

It can be seen from the comparison between Example 6 and Example 7 that the polyester plasticizer, which is obtained by using an alcohol end-capping agent to perform end-capping on a product of the esterification reaction, has better bending resistance at low temperature and better plasticizer retention than that obtained by using an acid end-capping agent to perform end-capping on a product of the esterification reaction.

### BENEFICIAL EFFECTS OF THE EMBODIMENTS

In conclusion, the polyester plasticizer having high cold resistance provided by the present disclosure, in which a main molecule chain contains a sebacic acid residue and a diethylene glycol residue and a residue derived from a diol having a silicon-oxygen structural unit (such as a silicon-oxygen bond or silicon-oxygen chain), a diol having a linear chain structure (such as 1,12-dodecanediol), or a diol having a branched chain structure (such as 2-butyl-2-ethyl-1,3-propanediol) linked to the sebacic acid residue, has excellent cold resistance and migration resistance characteristics, and can be used in a polyvinyl chloride composition, so as to improve a resulting PVC soft product in terms of low-temperature resistance, bendability, and plasticizer blooming.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyester plasticizer having high cold resistance, obtained by an esterification reaction of a diacid component with a diol component followed by end-capping with an end-capping agent, wherein the diacid component is sebacic acid, the diol component includes a first diol and a second diol, and the first diol is diethylene glycol and the second diol is a diol having a silicon-oxygen structural unit, a linear chain structure, or a branched chain structure.

2. The polyester plasticizer having high cold resistance according to claim 1, having a structure as represented by formula I: 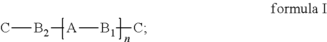
wherein, in formula I, A represents a residue of the sebacic acid; B₁ and B₂ each independently represent a residue of the first diol or the second diol; C represents a residue of the end-capping agent; and n is a positive integer from 1 to 4.

3. The polyester plasticizer having high cold resistance according to claim 2, wherein the diol having the silicon-oxygen structural unit has a structure as represented by formula II: 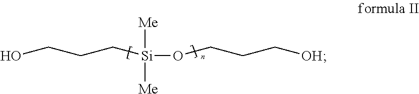
wherein Me in formula II represents a methyl group; the diol having the linear chain structure is 1,12-dodecanediol; the diol having the branched chain structure is 2-butyl-2-ethyl-1,3-propanediol; and n is a positive integer from 1 to 4.

4. The polyester plasticizer having high cold resistance according to claim 3, wherein the second diol is the diol having the silicon-oxygen structural unit, and B₁ and B₂ in formula I each independently represent a residue derived from the diethylene glycol or the diol having the silicon-oxygen structural unit.

5. The polyester plasticizer having high cold resistance according to claim 4, wherein the end-capping agent is an acid end-capping agent or an alcohol end-capping agent.

6. The polyester plasticizer having high cold resistance according to claim 5, wherein the end-capping agent is lauric acid.

7. The polyester plasticizer having high cold resistance according to claim 3, wherein the second diol is the diol having the linear chain structure, and B₁ and B₂ in formula I each independently represent a residue derived from the diethylene glycol or the diol having the linear chain structure.

8. The polyester plasticizer having high cold resistance according to claim 7, wherein the end-capping agent is an acid end-capping agent or an alcohol end-capping agent.

9. The polyester plasticizer having high cold resistance according to claim 8, wherein the end-capping agent is lauric acid.

10. The polyester plasticizer having high cold resistance according to claim 3, wherein the second diol is the diol having the branched chain structure, and B₁ and B₂ in formula I each independently represent a residue derived from the diethylene glycol or the diol having the branched chain structure.

11. The polyester plasticizer having high cold resistance according to claim 10, wherein the end-capping agent is an acid end-capping agent or an alcohol end-capping agent.

12. The polyester plasticizer having high cold resistance according to claim 11, wherein the end-capping agent is lauric acid.

13. A polyvinyl chloride composition for manufacturing a soft product, comprising 100 parts by weight of a polyvinyl chloride component, a plasticizer component, a stabilizer, and at least one inorganic additive, wherein the plasticizer component includes the polyester plasticizer having high cold resistance as claimed in claim 1.

14. The polyvinyl chloride composition according to claim 13, wherein the plasticizer component further includes a C9-C11 phthalate, and the C9-C11 phthalate and the polyester plasticizer having high cold resistance are in a ratio of 3:1.
